(19) United States
(12) Patent Application Publication
(10) Pub. No.: US 2025/0081108 A1
(43) Pub. Date: Mar. 6, 2025

(54) SIGNAL TRANSMISSION CONDITION DETERMINING METHOD AND APPARATUS, SSB PERIOD CONTROL METHOD AND APPARATUS, TERMINAL, AND NETWORK-SIDE DEVICE

(71) Applicant: VIVO MOBILE COMMUNICATION CO., LTD., Dongguan (CN)

(72) Inventors: Jianhui LI, Dongguan (CN); Gen LI, Dongguan (CN)

(73) Assignee: VIVO MOBILE COMMUNICATION CO., LTD., Dongguan (CN)

(21) Appl. No.: 18/948,408

(22) Filed: Nov. 14, 2024

Related U.S. Application Data
(63) Continuation of application No. PCT/CN2023/092994, filed on May 9, 2023.

(30) Foreign Application Priority Data
May 16, 2022 (CN) 202210529997.4

(51) Int. Cl. H04W 52/02; H04W 24/10; H04W 56/00

(52) U.S. Cl. CPC H04W 52/0235; H04W 24/10; H04W 56/0015

(57) ABSTRACT

A signal transmission condition determining method, a Synchronization Signal Block (SSB) period control method, and a terminal are provided. The signal transmission condition determining method includes receiving, by the terminal, a first SSB. The signal transmission condition determining method further includes determining, by the terminal based on the first SSB, whether a Wake-Up Signal (WUS) transmission condition is met.

### CROSS-REFERENCE TO RELATED APPLICATIONS

This application is a continuation of International Application No. PCT/CN2023/092994, filed on May 9, 2023, which claims priority to Chinese Patent Application No. 202210529997.4, filed on May 16, 2022. The entire contents of each of the above-referenced applications are expressly incorporated herein by reference.

### TECHNICAL FIELD

This application pertains to the field of wireless communication technologies, and specifically relates to a signal transmission condition determining method and apparatus, an SSB period control method and apparatus, a terminal, and a network-side device.

### BACKGROUND

At present, the operating mode of the network-side device may include a normal operating mode and an energy-saving mode. In the energy-saving mode, the network-side device shut down some or all downlink transmissions. When a network-side device is in an energy-saving mode, it is usually helped by a network device to return to the normal operating mode from the energy-saving mode.

At present, the terminal cannot reasonably determine whether the network-side device needs to be awakened. Therefore, when the network-side device is in the energy-saving mode and the terminal needs to perform cell switching, the terminal may not be able to search for a cell that can be camped on, which may lead to the failure of a cell switching behavior of the terminal. It can be seen that the terminal cannot reasonably determine whether the network-side device needs to be awakened, so the communication performance of the terminal will be affected.

### SUMMARY

Embodiments of this application provide a signal transmission condition determining method and apparatus, an SSB period control method and apparatus, a terminal, and a network-side device.

According to a first aspect, a signal transmission condition determining method is provided, where the method includes:

receiving, by a terminal, a first synchronization signal block SSB; and

determining, by the terminal based on the first SSB, whether a wake-up signal WUS transmission condition is met.

According to a second aspect, a signal transmission condition determining apparatus is provided, where the apparatus includes:

a first receiving module, configured to receive a first synchronization signal block SSB; and

a first determining module, configured to determine, based on the first SSB, whether a wake-up signal WUS transmission condition is met.

According to a third aspect, an SSB period control method is provided, where the method includes:

receiving, by a network-side device, a wake-up signal WUS transmitted by a terminal; and

switching, by the network-side device, a synchronization signal block SSB transmission period from a first period to a second period, where a duration of the first period is longer than a duration of the second period.

According to a fourth aspect, an SSB period control apparatus is provided, where the apparatus includes:

a receiving module, configured to receive a wake-up signal WUS transmitted by a terminal; and

a switching module, configured to switch a synchronization signal block SSB transmission period from a first period to a second period, where a duration of the first period is longer than a duration of the second period.

According to a fifth aspect, a terminal is provided, where the terminal includes a processor and a memory, the memory stores a program or instructions capable of running on the processor, and when the program or instructions are executed by the processor, the steps of the method according to the first aspect are implemented.

According to a sixth aspect, a terminal is provided and includes a processor and a communication interface, where the communication interface is configured to receive a first synchronization signal block SSB; and the processor is configured to determine, based on the first SSB, whether a wake-up signal WUS transmission condition is met.

According to a seventh aspect, a network-side device is provided, where the network-side device includes a processor and a memory, the memory stores a program or instructions capable of running on the processor, and when the program or the instructions are executed by the processor, the steps of the method according to the first aspect are implemented.

According to an eighth aspect, a network-side device is provided and includes a processor and a communication interface, where the communication interface is configured to receive a wake-up signal WUS transmitted by a terminal, and the processor is configured to switch a synchronization signal block SSB transmission period from a first period to a second period, where a duration of the first period is longer than a duration of the second period.

According to a ninth aspect, a communication system is provided and includes a terminal and a network-side device, where the terminal may be configured to perform the steps of the method according to the first aspect, and the network-side device may be configured to perform the steps of the method according to the third aspect.

According to a tenth aspect, a readable storage medium is provided, where the readable storage medium stores a program or instructions, and when the program or the instructions are executed by a processor, the steps of the method according to the first aspect are implemented, or the steps of the method according to the third aspect are implemented.

According to an eleventh aspect, a chip is provided, where the chip includes a processor and a communication interface, the communication interface is coupled to the processor, and the processor is configured to run a program or instructions to implement the steps of the method according to the first aspect or the steps of the method according to the third aspect.

According to a twelfth aspect, a computer program/program product is provided, where the computer program/program product is stored in a storage medium, and the computer program/program product is executed by at least one processor to implement the steps of the method according to the first aspect, or to implement the steps of the method according to the third aspect.

In the embodiments of this application, the terminal may determine, based on the received Synchronization Signal Block (SSB), whether the Wake-Up Signal (WUS) transmission condition is met. In this way, the terminal can reasonably determine whether the network-side device needs to be awakened, which can ensure that communication performance of the terminal is not affected by the network-side device being in the energy-saving mode.

### BRIEF DESCRIPTION OF DRAWINGS

FIG. 1 is a block diagram of a wireless communication system according to an embodiment of this application;

FIG. 2 is a flowchart of a signal transmission condition determining method according to an embodiment of this application;

FIG. 3 is a structural diagram of a signal transmission condition determining apparatus according to an embodiment of this application;

FIG. 4 is a flowchart of an SSB period control method according to an embodiment of this application;

FIG. 5 is a structural diagram of an SSB period control apparatus according to an embodiment of this application;

FIG. 6 is a structural diagram of a communication device according to an embodiment of this application;

FIG. 7 is a schematic structural diagram of hardware of a terminal according to an embodiment of this application; and

FIG. 8 is a schematic structural diagram of hardware of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It is worth noting that the technology described in the embodiments of this application is not limited to Long Term Evolution (LTE)/LTE-Advanced (LTE-A) systems, but may also be used in other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, NR terms are used in most of the following descriptions, and these technologies may also be applied to other applications than an NR system application, for example, the 6th Generation (6G) communication system.

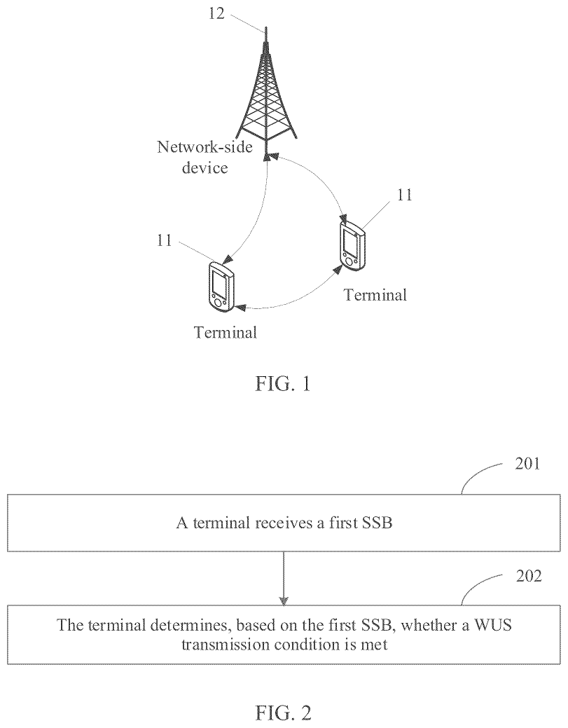

FIG. 1 is a block diagram of a wireless communication system to which the embodiments of this application are applicable. The wireless communication system includes a terminal 11 and a network device 12. The terminal 11 may be a terminal-side device, such as a mobile phone, a tablet personal computer, a laptop computer or notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), smart-home appliance (a smart-home device having a wireless communication function, for example, a refrigerator, a television, a washing machine, or furniture), a game console, a Personal Computer (PC), a teller machine, or a self-service machine. The wearable device includes a smart watch, a smart band, smart earphones, smart glasses, smart jewelry (a smart bracelet, a smart chain bracelet, a smart ring, a smart necklace, a smart anklet, a smart chain anklet, or the like), a smart wrist band, smart clothing, or the like. It should be noted that a specific type of the terminal 11 is not limited in the embodiments of this application. The network-side device 12 may include an access network device or a core network device, where the access network device may also be called a radio access network device, a Radio Access Network (RAN), a radio access network function, or a radio access network unit. The access network device may include a base station, a Wireless Local Area Network (WLAN) access point, or a Wireless Fidelity (Wi-Fi) node. The base station may be referred to as a NodeB, an evolved Node B (eNB), an access point, a Base Transceiver Station (BTS), a radio base station, a radio transceiver, a Basic Service Set (BSS), an Extended Service Set (ESS), a home NodeB, a home evolved NodeB, a Transmission and Reception Point (TRP), or another appropriate term in the art. Provided that the same technical effect is achieved, the base station is not limited to a specific technical term. It should be noted that the base station in the NR system is only used as an example in the embodiments of this application for illustration, but a specific type of the base station is not limited.

The following describes in detail the signal transmission condition determining method and apparatus, SSB period control method and apparatus, terminal, network-side device, and storage medium provided in the embodiments of this application by using some embodiments and application scenarios thereof with reference to the accompanying drawings.

Referring to FIG. 2, FIG. 2 is a flowchart of a signal transmission condition determining method according to an embodiment of this application. As shown in FIG. 2, the signal transmission condition determining method includes the following steps.

Step 201. A terminal receives a first SSB.

Step 202. The terminal determines, based on the first SSB, whether a WUS transmission condition is met.

Generally, a network-side device that can provide cell camping capability for the terminal needs to at least open uplink and downlink transmission channels, meaning that it needs to at least transmit a public signal SSB in a downlink direction and may receive a random access request from the terminal in an uplink direction. Therefore, the network-side device that can provide cell camping capability for the terminal may transmit an SSB in a downlink direction when being in an energy-saving mode. In this way, it becomes possible for the terminal to reasonably determine, based on the SSB transmitted by the network-side device, whether the network-side device is in the energy-saving mode and whether the network-side device needs to be awakened. Based on this, an embodiment of this application proposes to use an SSB as the basis for the terminal to determine whether the WUS transmission condition is met. The SSB may be understood as a Synchronization Signal Block or may be understood as a Synchronization Signal and Physical Broadcast Channel (PBCH) signal block.

In an embodiment of this application, the terminal may determine, based on the received SSB, whether the WUS transmission condition is met. In this way, the terminal can reasonably determine whether the network-side device needs to be awakened, which can ensure that communication performance of the terminal is not affected by the network-side device being in the energy-saving mode.

The terminal may determine, based on measurement of a serving cell reference signal or an energy-saving cell reference signal, whether a condition for transmitting a WUS to an energy-saving cell is met. However, for a terminal in an IDLE state, a public reference signal for current cells is generally only the SSB. Before detailing the various implementations provided in the embodiments of this application, for ease of understanding, the relevant content about the SSB is introduced as follows.

In a New Radio (NR) system, SSB is divided into two types: Cell-Defining SSB (CD-SSB) and Non Cell-Defining SSB (NCD-SSB). The CD-SSB is defined as an SSB associated with System Information Block 1 (SIB1). A frequency position of the CD-SSB is usually located on a system synchronization grid. SIB1 is also known as Remaining Minimum System Information (RMSI), and SIBI defines scheduling information of other SIBs and contains information for initial access of the terminal. The NCD-SSB is correspondingly defined as an SSB not associated with SIB1, and the NCD-SSB may be used for auxiliary cell synchronization or may be used for configuring a measurement signal for a terminal. A frequency position of the NCD-SSB is not necessarily located on a system synchronization grid. If the frequency position of the NCD-SSB is located on the system synchronization grid, a Global Synchronization Channel Number (GSCN) of the CD-SSB may be indicated through information the NCD-SSB carries.

A Subcarrier Offset information field of the SSB (ssb-SubcarrierOffset) is used for indicating a subcarrier offset value kss between the SSB and CORESET#0. This offset includes 0 to 23 subcarriers and 0 to 11 subcarriers, represented by 5 bits (where 4 bits are indicated by ssb-SubcarrierOffset and 1 bit by a Physical (PHY) layer of a Physical Broadcast Channel (PBCH)) and 4 bits respectively, corresponding to frequency ranges FR1 and FR2. When k_{SSB}>23 (FR1) or k_{SSB}>11 (FR2), the current SSB is an NCD-SSB. This value range is used for indicating that the current SSB is not associated with SIB1, but some of these values may be used for indicating the GSCN of the CD-SSB. When k_{SSB}=31 (FR1) or k_{SSB}=15 (FR2), the current SSB is an NCD-SSB, and the terminal may consider that there is no CD-SSB within a GSCN range.

It can be seen that the terminal may determine, based on a subcarrier offset information field value k_{SSB} of the SSB, whether there is a CD-SSB, or whether a CD-SSB can be searched, or whether there is a cell that can be camped on. In this way, in the embodiments of this application, the terminal may reasonably determine, based on k_{SSB} of the first SSB, whether the network-side device needs to be awakened. The following provides detailed descriptions of relevant implementations provided in the embodiments of this application.

In some embodiments, that the terminal determines, based on the first SSB, whether a

WUS transmission condition is met includes:

in a case that a subcarrier offset information field value of the first SSB is a first value, the terminal determines that the WUS transmission condition is met, where the first value is used for indicating that the first SSB is a non-cell-defining SSB.

In this implementation, after receiving the first SSB, the terminal may decode the first SSB in a PBCH to obtain the subcarrier offset information field value k_{SSB} of the first SSB. k_{SSB} being the first value may be that k_{SSB}=24 to 31 (FR1), and k_{SSB}=12 to 15 (FR2). In an example, k_{SSB}=30 or 31 (FR1), and k_{SSB}=14 or 15 (FR2). In this example, k_{SSB} is used for indicating that the first SSB is an NCD-SSB and that the first SSB does not indicate the GSCN of the CD-SSB, meaning that the first SSB indicates that there is no cell that can be camped on in a current region. In another example, k_{SSB}=24 to 29 (FR1), and k_{SSB}=12 to 13 (FR2). In this example, k_{SSB} is used for indicating that the first SSB is an NCD-SSB and that the first SSB indicates the GSCN of the

CD-SSB, meaning that the first SSB indicates that there is a cell that can be camped on in a current region.

In this implementation, if k_{SSB} indicates that the first SSB is an NCD-SSB, the terminal may consider that a cell transmitting the first SSB is an energy-saving cell (that is, a cell in the energy-saving mode), and the terminal may determine that the WUS transmission condition is met.

In some embodiments, the method further includes that: in a case that the terminal determines that the WUS transmission condition is met, the terminal transmits a WUS to the cell transmitting the first SSB. In this way, the terminal can awaken an energy-saving cell in a timely manner by transmitting a WUS to the energy-saving cell, thereby providing conditions for behaviors such as random access or cell switching that the terminal may need to perform.

In some embodiments, that the terminal determines, based on the first SSB, whether a WUS transmission condition is met includes:

in a case that a subcarrier offset information field value of the first SSB is a first value and a first cell identifier is an energy-saving cell identifier, the terminal determines that the WUS transmission condition is met, where the first cell identifier is an identifier of a cell transmitting the first SSB, and the first value is used for indicating that the first SSB is a non-cell-defining SSB.

In this implementation, after receiving the first SSB, the terminal may decode the first SSB in a PBCH to obtain the subcarrier offset information field value k_{SSB} of the first SSB and the first cell identifier. kSSB being the first value may be that kSSB=24 to 31 (FR1), and kSSB=12 to 15 (FR2). In an example, kSSB=30 or 31 (FR1), and kSSB=14 or 15 (FR2). In this example, kSSB is used for indicating that the first SSB is an NCD-SSB and that the first SSB does not indicate the GSCN of the CD-SSB, meaning that the first SSB indicates that there is no cell that can be camped on in a current region. In another example, kSSB=24 to 29 (FR1), and kSSB=12 to 13 (FR2). In this example, kSSB is used for indicating that the first SSB is an NCD-SSB and that the first SSB indicates the GSCN of the CD-SSB, meaning that the first SSB indicates that there is a cell that can be camped on in a current region.

In this implementation, if k_{SSB} indicates that the first SSB is an NCD-SSB and an identifier of the cell transmitting the first SSB is an energy-saving cell identifier, the terminal may consider that the cell transmitting the first SSB is an energy-saving cell, and the terminal may determine that the WUS transmission condition is met.

The terminal may determine, based on energy-saving cell configuration information configured by a serving cell, whether the first cell identifier is an energy-saving cell identifier.

In this implementation, the terminal determines, in combination with the energy-saving cell identifier and k_{SSB}, whether the WUS transmission condition is met. Compared to the related art where a terminal determines, based on only an energy-saving cell identifier, whether a cell is an energy-saving cell, this implementation can reasonably exclude the possibility that an energy-saving cell has already switched from an energy-saving mode to a normal operating mode, allowing the terminal to more reasonably determine whether the network-side device needs to be awakened.

In some embodiments, the method further includes that: in a case that the terminal determines that the WUS transmission condition is met, the terminal transmits a WUS to the cell transmitting the first SSB. In this way, the terminal can awaken an energy-saving cell in a timely manner by transmitting a WUS to the energy-saving cell, thereby providing conditions for behaviors such as random access or cell switching that the terminal may need to perform.

For the network-side device, when receiving the WUS transmitted by the terminal, the network-side device may switch a an SSB transmission period from a first period to a second period, where a duration of the first period is longer than a duration of the second period. For example, the first period may be 80 ms, 160 ms, or longer, and the second period may be 20 ms or the like.

In some embodiments, that the terminal determines, based on the first SSB, whether a WUS transmission condition is met includes:

in a case that a subcarrier offset information field value of the first SSB is a second value and a first cell identifier is an energy-saving cell identifier, the terminal determines that the WUS transmission condition is met; where

the second value is used for indicating that the first SSB is an NCD-SSB, the first SSB indicates the presence of a CD-SSB, and the first cell identifier is an identifier of a cell transmitting the first SSB.

In this implementation, after receiving the first SSB, the terminal may decode the first SSB in a PBCH to obtain the subcarrier offset information field value kSSB of the first SSB and the first cell identifier. In an example, k_{SSB} being a second value may be that: k_{SSB}=24 to 29 (FR1), and k_{SSB}=12 to 13 (FR2). In this example, k_{SSB} is used for indicating that the first SSB is an NCD-SSB, and the first SSB indicates the presence of a CD-SSB. It should be noted that the indication of the presence of a CD-SSB by the first SSB can be understood as the first SSB indicating the GSCN of the CD-SSB.

The terminal may find the GSCN of the CD-SSB through the first SSB. For example, the terminal may find the GSCN of the CD-SSB through table lookup and may consider that jumping to that GSCN may receive a CD-SSB. However, time-domain positions of the CD-SSB and the NCD-SSB are not necessarily related. If the energy-saving cell saves energy using a method of adjusting an SSB period to a long period (for example, 80 ms, 160 ms, or longer), and the terminal generally searches for a cell at a period of 20 ms by default, the terminal may not immediately receive the CD-SSB and may consider that no CD-SSB exists.

Based on this, in a case that the first cell identifier is an energy-saving cell identifier and the subcarrier offset information field value of the first SSB is the second value, the cell transmitting the first SSB may be in an energy-saving mode, and the terminal may not be able to receive the CD-SSB. In this case, the terminal may consider the cell transmitting the first SSB as an energy-saving cell, and the terminal may determine that the WUS transmission condition is met.

In this implementation, the terminal may determine whether the first cell identifier is an energy-saving cell identifier through the energy-saving cell configuration information configured by the serving cell.

In some embodiments, the method further includes that: in a case that the terminal determines that the WUS transmission condition is met, the terminal transmits a WUS to the cell transmitting the first SSB. In this way, the terminal can awaken an energy-saving cell in a timely manner by transmitting a WUS to the energy-saving cell, thereby providing conditions for behaviors such as random access or cell switching that the terminal may need to perform.

For the network-side device, when receiving the WUS transmitted by the terminal, the network-side device may switch a an SSB transmission period from a first period to a second period, where a duration of the first period is longer than a duration of the second period. For example, the first period may be 80 ms, 160 ms, or longer, and the second period may be 20 ms or the like.

It should be noted that in this implementation, the terminal may directly determine that the WUS transmission condition is met, or may determine that the WUS transmission condition is met after no CD-SSB is detected. The latter implementation is described below.

In some embodiments, that in a case that a subcarrier offset information field value of the first SSB is a second value and a first cell identifier is an energy-saving cell identifier, the terminal determines that the WUS transmission condition is met includes:

in the case that the subcarrier offset information field value of the first SSB is the second value and the first cell identifier is the energy-saving cell identifier, if the terminal detects no SSB at a frequency domain position corresponding to a target GSCN in a CD-SSB reception window duration, the terminal determines that the WUS transmission condition is met, where the target GSCN is a GSCN of CD-SSB indicated by the first SSB, and the cell-defining SSB reception window duration is prescribed by a protocol or pre-configured.

In this implementation, the SSB is detected at the GSCN position of the CD-SSB indicated by the first SSB. If the terminal detects no SSB at that GSCN position within the CD-SSB reception window duration, the terminal may consider that the currently cell that can be camped on is only the cell transmitting the first SSB and consider that the cell is an energy-saving cell, and the terminal may determine that the WUS transmission condition is met. The CD-SSB reception window duration may be denoted as T0, and a value of T0 may be prescribed by a protocol (for example, T0=20 ms) or may be pre-configured by a cell.

In addition, considering a case that the energy-saving cell SSB period is pre-configured, the terminal may make a more reasonable determination or perform a more reasonable behavior by further combining, on the basis of the foregoing implementations, whether the energy-saving cell SSB period is pre-configured. The following describes relevant implementations.

In some embodiments, that the terminal determines, based on the first SSB, whether a WUS transmission condition is met includes:

in a case that a subcarrier offset information field value of the first SSB is a second value, a first cell identifier is an energy-saving cell identifier, and no energy-saving cell SSB period is pre-configured, the terminal determines that the WUS transmission condition is met; where

the second value is used for indicating that the first SSB is an NCD-SSB, the first SSB indicates the presence of a CD-SSB, and the first cell identifier is an identifier of a cell transmitting the first SSB.

The energy-saving cell SSB period may be pre-configured in the energy-saving cell configuration information.

In some embodiments, that in a case that a subcarrier offset information field value of the first SSB is a second value, a first cell identifier is an energy-saving cell identifier, and no energy-saving cell SSB period is pre-configured, the terminal determines that the WUS transmission condition is met includes:

in the case that the subcarrier offset information field value of the first SSB is the second value, the first cell identifier is the energy-saving cell identifier, and no energy-saving cell SSB period is pre-configured, if the terminal detects no SSB at a frequency domain position corresponding to a target GSCN in a CD-SSB reception window duration, the terminal determines that the WUS transmission condition is met, where the target GSCN is a GSCN of the CD-SSB indicated by the first SSB, and the CD-SSB reception window duration is prescribed by a protocol or pre-configured.

In the foregoing implementation, in the case that the energy-saving cell SSB period is not pre-configured, the terminal executes the solution of determining, based on the subcarrier offset information field value of the first SSB and the first cell identifier, whether the WUS transmission condition is met. As the previous implementation have already provided detailed descriptions of the relevant solution for determining, based on the subcarrier offset information field value of the first SSB and the first cell identifier, whether the WUS transmission condition is met, this implementation will not be repeated to avoid repetition.

In some embodiments, the method further includes:

in a case that the energy-saving cell SSB period has been pre-configured, the terminal detects, based on the energy-saving cell SSB period, an SSB at a frequency domain position corresponding to the target GSCN.

In this implementation, in the case that the energy-saving cell SSB period has been pre-configured, the terminal detects, based on the energy-saving cell SSB period, the SSB at the frequency domain position corresponding to the target GSCN.

It should be noted that as the terminal can know the energy-saving cell SSB period, the terminal can usually detect the SSB at the frequency domain position corresponding to the target GSCN based on this period, so that the terminal can usually find a cell that can be camped on. Based on this, the terminal does not need to transmit a WUS to the cell transmitting the first SSB.

In an embodiment of this application, information such as the energy-saving cell identifier, the energy-saving cell SSB period, and the CD-SSB reception window duration may be configured by a serving cell in energy-saving cell configuration information. Relevant implementations for configuring energy-saving cell configuration information by the serving cell are described below.

In some embodiments, the method further includes:

the terminal receives energy-saving cell configuration information configured by a serving cell, where the energy-saving cell configuration information includes at least one of:

an energy-saving cell identifier;

an energy-saving cell WUS reception parameter;

an energy-saving cell WUS reception offset value;

an energy-saving cell SSB period; and

a CD-SSB reception window duration.

It should be noted that the energy-saving cell configuration information mentioned above may be provided in one or may be provided in plurality. For example, the energy-saving cell configuration information may include one or more energy-saving cell identifiers, the energy-saving cell configuration information may include one or more energy-saving cell WUS reception parameters, the energy-saving cell configuration information may include one or more energy-saving cell WUS reception offset values, the energy-saving cell configuration information may include one or more energy-saving cell SSB periods, and the energy-saving cell configuration information may include one or more cell-defined SSB reception window durations. The energy-saving cell configuration information may be configured in a form of list. For example, the energy-saving cell identifier may be configured in a form of energy-saving cell identifier list.

The energy-saving cell identifier may be a Physical Cell Identifier (PCI) of the energy-saving cell.

In some embodiments, the method further includes at least one of the following:

the terminal determines, based on the energy-saving cell configuration information, whether the first cell identifier is an energy-saving cell identifier; and

in a case that the terminal determines that the WUS transmission condition is met, the terminal transmits, based on the energy-saving cell configuration information, a WUS to a cell transmitting the first SSB.

After decoding the first SSB to obtain the first cell identifier carried by the first SSB, the terminal may query whether there is an energy-saving cell identifier that is the same as or matches the first cell identifier in the energy-saving cell configuration information configured by the serving cell, and if such energy-saving cell identifier exists, the terminal determines that the first cell identifier is an energy-saving cell identifier. In an example, if the energy-saving cell configuration information configured by the serving cell includes an energy-saving cell identifier list, where the list includes identifiers of a plurality of energy-saving cells, the terminal may query the energy-saving cell identifier list, and if the first cell identifier is one of the identifiers in the energy-saving cell identifier list, the terminal may determine that the first cell identifier is an energy-saving cell identifier.

In the case that the terminal determines that the WUS transmission condition is met, the terminal may also transmit, based on the energy-saving cell configuration information, the WUS to the cell transmitting the first SSB. For example, the terminal may determine a WUS transmission parameter based on the energy-saving cell WUS reception parameter and WUS reception offset value, and transmit, based on the WUS transmission parameter, the WUS to the cell transmitting the first SSB.

In some embodiments, the energy-saving cell WUS reception parameter includes at least one of the following:

energy-saving cell WUS reception frame number;

energy-saving cell WUS reception subframe number;

energy-saving cell WUS reception slot number;

energy-saving cell WUS reception symbol number; and

energy-saving cell WUS reception resource block or WUS reception resource set.

In some embodiments, the energy-saving cell WUS reception offset value includes at least one of the following:

an offset value between an energy-saving cell WUS reception position and a position at which the first SSB is detected by the terminal; and

an offset value between the energy-saving cell WUS reception position and a predefined parameter, where the predefined parameter includes at least one of predefined frame number, predefined subframe number, predefined slot number, and predefined symbol number.

The foregoing are the relevant implementations provided in this embodiment of this application, where the terminal makes a relevant determination, based on k_{SSB} of the SSB and further combining factors such as cell identifier and SSB period, on whether the network-side device needs to be awakened.

Through the foregoing implementations, the energy-saving cell may indicate whether it is an energy-saving cell by simply changing the description of an information field on an existing SSB mechanism. Therefore, the terminal may quickly determine whether the WUS transmission condition is met or whether to transmit the WUS by measuring the SSB transmitted by the energy-saving cell. This can effectively avoid the loss of network connection due to the inability to awaken the energy-saving cell in a timely manner and ensure that the communication performance of the terminal is not affected by the network-side device being in the energy-saving mode.

The following are the relevant implementations provided in this embodiment of this application, where the terminal makes a relevant determination, based on a measurement result of the SSB of the serving cell and further combining a factor such as terminal mobility, on whether the network-side device needs to be awakened.

In some embodiments, that the terminal determines, based on the first SSB, whether a WUS transmission condition is met includes:

in a case that the first SSB is an SSB transmitted by the serving cell, the terminal determines, according to a measurement result of the first SSB, whether the WUS transmission condition is met.

The measurement result of the first SSB may include at least one of Reference Signal Received Power (RSRP), Reference Signal Received Quality (RSRQ), Signal to Interference plus Noise Ratio (SINR), and Received Signal Strength Indication (RSSI).

In this implementation, a preset threshold may be set, so that the terminal may need to perform behaviors such as cell switching and cell reselection in a case that the measurement result of the first SSB is lower than the preset threshold. To ensure there is a cell that can be camped on, the terminal may determine that the WUS transmission condition is met to awaken a cell in the energy-saving mode.

It should be noted that in the case that the terminal determines that the WUS transmission condition is met, how the terminal transmits the WUS and to what object the WUS is transmitted are not limited in this implementation, and the terminal may flexibly determine based on other conditions or its own needs.

As the mobility of terminals varies, high-speed terminals may leave the effective coverage of a serving cell faster than normal-speed terminals. For a terminal in an IDLE state, if the terminal is in a high-speed state and cannot transmit a WUS to the energy-saving cell in a timely manner, it may face the problem of not being able to find an available neighboring cell, or because of issues such as desynchronization with the serving cell, the transmitted WUS may not fall within the window where the energy-saving cell expects to receive the WUS. For a terminal in a CONNECTED state, if the terminal is in a high-speed state and cannot transmit a WUS in a timely manner to wake up the energy-saving cell, an expected cell switching behavior may fail because the terminal has a Radio Link Failure (RLF) to the serving cell or the energy-saving cell cannot wake up in a timely manner. Based on this, on the basis of the aforementioned implementation, the terminal may determine, further combining a mobility factor of the terminal, whether the WUS transmission condition is met.

In some embodiments, that the terminal determines, according to a measurement result of the first SSB, whether the WUS transmission condition is met includes:

in a case that the measurement result of the first SSB is lower than a WUS configuration parameter corresponding to a mobility state of the terminal, the terminal determines that the WUS transmission condition is met, where the WUS configuration parameter is configured by the serving cell.

When the terminal camps on a serving cell, the terminal may determine a mobility state of the terminal through a parameter configured in system information block 2 SIB2 of the serving cell. The serving cell may pre-configure WUS configuration parameters of different sizes for different mobility states. When the terminal is in a different mobility state, it may compare the measurement result of the first SSB with a corresponding WUS configuration parameter to determine whether the WUS transmission condition is met.

In some embodiments, the WUS configuration parameter includes at least one of the following:

a first parameter, where the first parameter is a parameter used by the terminal in a first mobility state;

a second parameter, where the first parameter is a parameter used by the terminal in a second mobility state; and

a third parameter, the first parameter is a parameter used by the terminal in a third mobility state; where

a moving speed corresponding to the first mobility state is less than a moving speed corresponding to the second mobility state, and the moving speed corresponding to the second mobility state is less than a moving speed corresponding to the third mobility state.

Mobility states of the terminal may include three types: normal speed, medium speed, and high speed. The first mobility state may correspond to the normal-speed mobility state, the second mobility state may correspond to the medium-speed mobility state, and the third mobility state may correspond to the high-speed mobility state. The serving cell may configure a parameter for the terminal to determine its mobility state through a mobility state parameter (mobilityStateParameters) in common cell reselection information in SIB2, for the terminal to determine whether a current mobility state of the terminal is normal speed, medium speed, or high speed.

In an example, when a quantity of cells reselected by the terminal within a t-Evaluation time is less than n-CellChangeMedium, the terminal may consider that the mobility state is normal speed; when a quantity of cells reselected by the terminal within a t-Evaluation time is greater than n-CellChangeMedium and less than n-CellChangeHigh, the terminal may consider that the mobility state is medium speed; and when a quantity of cells reselected by the terminal within a t-Evaluation time is greater than n-CellChangeHigh, the terminal may consider that the mobility state is high speed.

In some embodiments, the first parameter, the second parameter, and the third parameter are respectively a first threshold, a second threshold, and a third threshold.

For example, when the terminal determines, based on a parameter configured in SIB2, that it is in the normal-speed state, and the measurement result of the SSB of the serving cell measured by the terminal is lower than a first threshold T1, the terminal may consider that the WUS transmission condition is met. When the terminal determines, based on a parameter configured in SIB2, that it is in the medium-speed state, and the measurement result of the SSB of the serving cell measured by the terminal is lower than a second threshold T2, the terminal may consider that the WUS transmission condition is met. When the terminal determines, based on a parameter configured in SIB2, that it is in the high-speed state, and the measurement result of the SSB of the serving cell measured by the terminal is lower than a third threshold T3, the terminal may consider that the WUS transmission condition is met.

In some embodiments, the first parameter is a first threshold, the second parameter is a first proportional factor of the first threshold, and the third parameter is a second proportional factor of the first threshold.

For example, when the terminal determines, based on a parameter configured in SIB2, that it is in the normal-speed state, and the measurement result of the SSB of the serving cell measured by the terminal is lower than a first threshold T1, the terminal may consider that the WUS transmission condition is met. When the terminal determines, based on a parameter configured in SIB2, that it is in the medium-speed state, and the measurement result of the SSB of the serving cell measured by the terminal is lower than T1*Pmedium, the terminal may consider that the WUS transmission condition is met. When the terminal determines, based on a parameter configured in SIB2, that it is in the high-speed state, and the measurement result of the SSB of the serving cell measured by the terminal is lower than T1*Phigh, the terminal may consider that the WUS transmission condition is met. Herein, Pmedium represents the first proportional factor, and Phigh represents the second proportional factor.

In some embodiments, the method further includes:

in a case that the terminal determines that the WUS transmission condition is met, the terminal reports a first message to the serving cell, where the first message is used for indicating a condition that the WUS transmission condition meets.

The foregoing are the relevant implementations provided in this embodiment of this application, where the terminal determines, based on the measurement result of the SSB of the serving cell and further combining a factor such as terminal mobility, whether the network-side device needs to be awakened.

Through the foregoing implementations, the terminal may determine whether the WUS transmission condition is met in a timely manner, which can effectively avoid the loss of network connection due to the inability to awaken the energy-saving cell in a timely manner and ensure that the communication performance of the terminal is not affected by the network-side device being in the energy-saving mode.

The signal transmission condition determining method provided in the embodiments of this application may be executed by a signal transmission condition determining apparatus. A signal transmission condition determining apparatus provided in an embodiment of this application is described by assuming that the signal transmission condition determining method in the embodiments of this application is performed by the signal transmission condition determining apparatus.

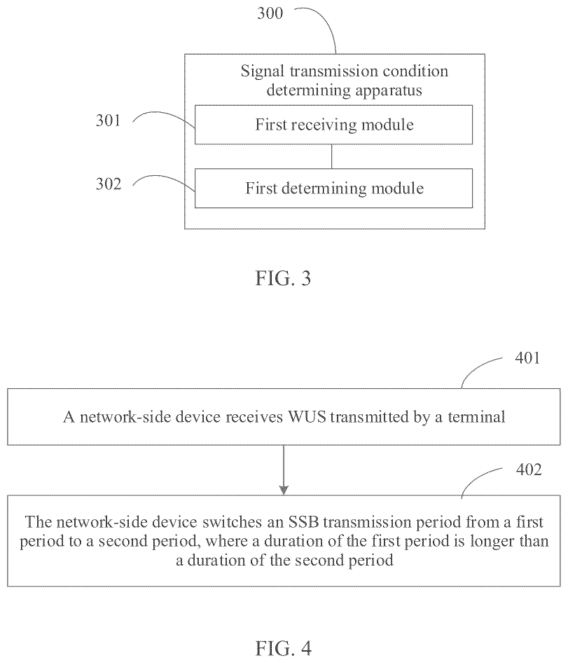

FIG. 3 is a structural diagram of a signal transmission condition determining apparatus according to an embodiment of this application. As shown in FIG. 3, the signal transmission condition determining apparatus 300 includes:

a first receiving module 301, configured to receive a first synchronization signal block SSB; and

a first determining module 302, configured to determine, based on the first SSB, whether a wake-up signal WUS transmission condition is met.

In some embodiments, the first determining module 302 is configured to:

in a case that a subcarrier offset information field value of the first SSB is a first value, determine that the WUS transmission condition is met, where the first value is used for indicating that the first SSB is a non-cell-defining SSB.

In some embodiments, the first determining module 302 is configured to:

in a case that a subcarrier offset information field value of the first SSB is a first value and a first cell identifier is an energy-saving cell identifier, determine that the WUS transmission condition is met, where the first cell identifier is an identifier of a cell transmitting the first SSB, and the first value is used for indicating that the first SSB is a non-cell-defining SSB.

In some embodiments, the first determining module 302 is configured to:

in a case that a subcarrier offset information field value of the first SSB is a second value and a first cell identifier is an energy-saving cell identifier, determine that the WUS transmission condition is met; where

the second value is used for indicating that the first SSB is a non-cell-defining SSB, the first SSB indicates the presence of a cell-defining SSB, and the first cell identifier is an identifier of a cell transmitting the first SSB.

In some embodiments, the first determining module 302 is configured to:

in the case that the subcarrier offset information field value of the first SSB is the second value and the first cell identifier is the energy-saving cell identifier, if the terminal detects no SSB at a target global synchronization channel number GSCN in a cell-defining SSB reception window duration, determine that the WUS transmission condition is met, where the target GSCN is a GSCN of the cell-defining SSB indicated by the first SSB, and the cell-defining SSB reception window duration is prescribed by a protocol or pre-configured.

In some embodiments, the first determining module 302 is configured to:

in a case that a subcarrier offset information field value of the first SSB is a second value, a first cell identifier is an energy-saving cell identifier, and no energy-saving cell SSB period is pre-configured, determine that the WUS transmission condition is met; where

the second value is used for indicating that the first SSB is a non-cell-defining SSB, the first SSB indicates the presence of a cell-defining SSB, and the first cell identifier is an identifier of a cell transmitting the first SSB.

In some embodiments, the first determining module 302 is configured to:

in a case that the subcarrier offset information field value of the first SSB is the second value, the first cell identifier is the energy-saving cell identifier, and no energy-saving cell SSB period is pre-configured, if the terminal detects no SSB at a target global synchronization channel number GSCN in a cell-defining SSB reception window duration, determine that the WUS transmission condition is met, where the target GSCN is a GSCN of the cell-defining SSB indicated by the first SSB, and the cell-defining SSB reception window duration is prescribed by a protocol or pre-configured.

In some embodiments, the signal transmission condition determining apparatus 300 further includes:

a detection module, configured to, in a case that the energy-saving cell SSB period has been pre-configured, detect, based on the energy-saving cell SSB period, an SSB at a frequency domain position corresponding to the target GSCN.

In some embodiments, the signal transmission condition determining apparatus 300 further includes:

a first transmitting module, configured to, in a case that the WUS transmission condition is determined to be met, transmit a WUS to the cell transmitting the first SSB.

In some embodiments, the signal transmission condition determining apparatus 300 further includes:

a second receiving module, configured to receive energy-saving cell configuration information configured by a serving cell, where the energy-saving cell configuration information includes at least one of:

an energy-saving cell identifier;

an energy-saving cell WUS reception parameter;

an energy-saving cell WUS reception offset value;

an energy-saving cell SSB period; and

a cell-defining SSB reception window duration.

In some embodiments, the signal transmission condition determining apparatus 300 further includes at least one of the following:

a second determining module, configured to determine, based on the energy-saving cell configuration information, whether the first cell identifier is an energy-saving cell identifier; and

a third determining module, configured to, in a case that the WUS transmission condition is determined to be met, transmit, based on the energy-saving cell configuration information, a WUS to a cell transmitting the first SSB.

In some embodiments, the energy-saving cell WUS reception parameter includes at least one of the following:

energy-saving cell WUS reception frame number;

energy-saving cell WUS reception subframe number;

energy-saving cell WUS reception slot number;

energy-saving cell WUS reception symbol number; and

energy-saving cell WUS reception resource block or WUS reception resource set.

In some embodiments, the energy-saving cell WUS reception offset value includes at least one of the following:

an offset value between an energy-saving cell WUS reception position and a position at which the first SSB is detected by the terminal; and

an offset value between the energy-saving cell WUS reception position and a predefined parameter, where the predefined parameter includes at least one of predefined frame number, predefined subframe number, predefined slot number, and predefined symbol number.

In some embodiments, the first determining module 302 is configured to:

in a case that the first SSB is an SSB transmitted by the serving cell, determine, according to a measurement result of the first SSB, whether the WUS transmission condition is met.

In some embodiments, the first determining module 302 is configured to:

in a case that the measurement result of the first SSB is lower than a WUS configuration parameter corresponding to a mobility state of the terminal, determine that the WUS transmission condition is met, where the WUS configuration parameter is configured by the serving cell.

In some embodiments, the WUS configuration parameter includes at least one of the following:

a first parameter, where the first parameter is a parameter used by the terminal in a first mobility state;

a second parameter, where the first parameter is a parameter used by the terminal in a second mobility state; and

a third parameter, the first parameter is a parameter used by the terminal in a third mobility state; where

a moving speed corresponding to the first mobility state is less than a moving speed corresponding to the second mobility state, and the moving speed corresponding to the second mobility state is less than a moving speed corresponding to the third mobility state.

In some embodiments, the first parameter, the second parameter, and the third parameter are respectively a first threshold, a second threshold, and a third threshold; or

the first parameter is a first threshold, the second parameter is a first proportional factor of the first threshold, and the third parameter is a second proportional factor of the first threshold.

In some embodiments, the signal transmission condition determining apparatus 300 further includes:

a second transmitting module, configured to, in a case that the terminal determines that the WUS transmission condition is met, report a first message to the serving cell, where the first message is used for indicating a condition that the WUS transmission condition meets.

In summary, in this embodiment of this application, the terminal may determine, based on the received SSB, whether the WUS transmission condition is met. In this way, the terminal can reasonably determine whether the network-side device needs to be awakened, which can ensure that communication performance of the terminal is not affected by the network-side device being in the energy-saving mode.

The signal transmission condition determining apparatus in this embodiment of this application may be an electronic device, for example, an electronic device with an operating system, or may be a component in an electronic device, for example, an integrated circuit or a chip. The electronic device may be a terminal or may be another device except the terminal. For example, the terminal may include but is not limited to the types of the terminal 11 listed above, and the another device may be a server, a Network Attached Storage (NAS), or the like, which are not limited in the embodiments of this application.

The signal transmission condition determining apparatus provided in this embodiment of this application can implement the processes implemented by the method embodiment in FIG. 2, with the same technical effects achieved. To avoid repetition, details are not described herein again.

FIG. 4 shows a flowchart of an SSB period control method according to an embodiment of this application. As shown in FIG. 4, the SSB period control method includes the following steps.

Step 401. A network-side device receives WUS transmitted by a terminal.

Step 402. The network-side device switches an SSB transmission period from a first period to a second period, where a duration of the first period is longer than a duration of the second period.

After receiving the WUS transmitted by the terminal, the network-side device may switch from an energy-saving mode to a normal operating mode. In one case, the network-side device saves energy by adjusting an SSB period to a long period, so the terminal may not immediately receive a CD-SSB. Based on this, in an embodiment of this application, after receiving the WUS transmitted by the terminal, the network-side device may switch the SSB transmission period from the first period to the second period. This can increase the probability that the terminal receives a CD-SSB, thus effectively avoiding the terminal losing network connection due to a long SSB period, and ensuring that the communication performance of the terminal is not affected by the network-side device being in an energy-saving mode.

For the relevant description of this embodiment of this application, reference may be made to the relevant description of the method embodiment shown in FIG. 2, with the same effects achieved. To avoid repetition, details are not described herein again.

The SSB period control method provided in the embodiments of this application may be executed by an SSB period control apparatus. An SSB period control apparatus provided in an embodiment of this application is described by assuming that the SSB period control method in the embodiments of this application is performed by the SSB period control apparatus.

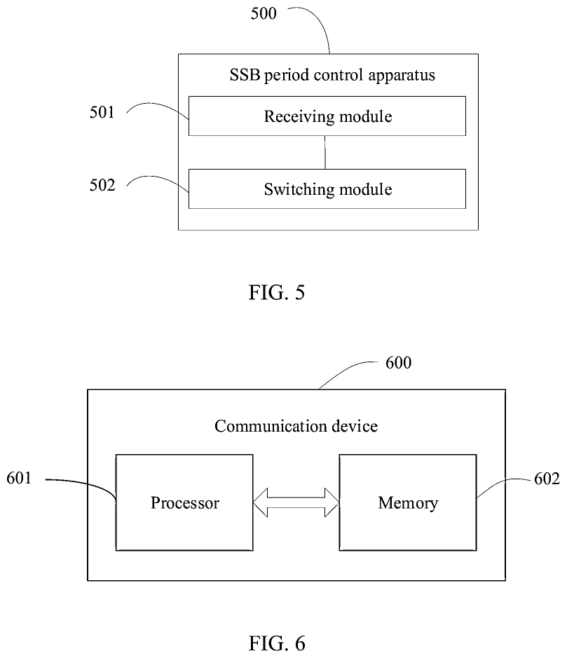

FIG. 5 is a structural diagram of an SSB period control apparatus according to an embodiment of this application. As shown in FIG. 5, the SSB period control apparatus 500 includes:

a receiving module 501, configured to receive a wake-up signal WUS transmitted by a terminal; and

a switching module 502, configured to switch a synchronization signal block SSB transmission period from a first period to a second period, where a duration of the first period is longer than a duration of the second period.

In this embodiment of this application, after the WUS transmitted by the terminal is received, the SSB transmission period may be switched from the first period to the second period. This can increase the probability that the terminal receives a CD-SSB, thus effectively avoiding the terminal losing network connection due to a long SSB period, and ensuring that the communication performance of the terminal is not affected by the network-side device being in an energy-saving mode.

The SSB period control apparatus in this embodiment of this application may be an electronic device, for example, an electronic device with an operating system, or may be a component in an electronic device, for example, an integrated circuit or a chip. The electronic device may be a terminal or may be another device except the terminal. For example, the terminal may include but is not limited to the types of the terminal 11 listed above, and the another device may be a server, a NAS, or the like, which are not limited in the embodiments of this application.

The SSB period control apparatus provided in this embodiment of this application can implement the processes implemented by the method embodiment in FIG. 4, with the same technical effects achieved. To avoid repetition, details are not repeated herein.

For example, as shown in FIG. 6, an embodiment of this application further provides a communication device 600, including a processor 601 and a memory 602, where the memory 602 stores a program or instructions capable of running on the processor 601. For example, when the communication device 600 is a terminal, the program or instructions are executed by the processor 601 to implement the steps of the signal transmission condition determining method embodiment described above, with the same technical effects achieved. When the communication device 600 is a network-side device, the program or instructions are executed by the processor 601 to implement the steps of the SSB period control method embodiment described above, with the same technical effects achieved. To avoid repetition, details are not elaborated herein.

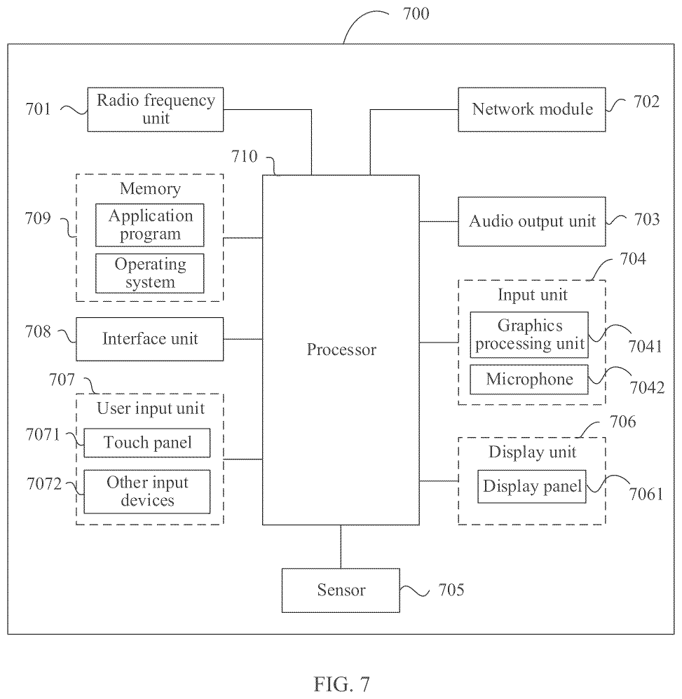

An embodiment of this application further provides a terminal, including a processor and a communication interface, where the communication interface is configured to receive a first synchronization signal block SSB; and the processor is configured to determine, based on the first SSB, whether a wake-up signal WUS transmission condition is met. This terminal embodiment corresponds to the foregoing method embodiment on the terminal side. All implementations in the foregoing method embodiment may be applicable to this terminal embodiment, with the same technical effects achieved. For example, FIG. 7 is a schematic structural diagram of hardware of a terminal for implementing embodiments of this application.

The terminal 700 includes, but is not limited to, at least some of components such as a radio frequency unit 701, a network module 702, an audio output unit 703, an input unit 704, a sensor 705, a display unit 706, a user input unit 707, an interface unit 708, a memory 709, and a processor 710.

Persons skilled in the art can understand that the terminal 700 may further include a power supply (for example, a battery) supplying power to the components, and the power supply may be logically connected to the processor 710 through a power management system. In this way, functions such as charge management, discharge management, and power consumption management are implemented by using the power management system. The structure of the terminal shown in FIG. 7 does not constitute any limitation on the terminal. The terminal may include more or fewer components than shown in the figure, or a combination of some components, or the components disposed differently. Details are not described herein again.

It should be understood that in this embodiment of this application, the input unit 704 may include a Graphics Processing Unit (GPU) 7041 and a microphone 7042. The graphics processing unit 7041 processes image data of a static picture or a video that is obtained by an image capture apparatus (for example, a camera) in a video capture mode or an image capture mode. The display unit 706 may include a display panel 7061, and the display panel 7061 may be configured in a form of a liquid crystal display, an organic light-emitting diode, and the like. The user input unit 707 includes at least one of a touch panel 7071 and other input devices 7072. The touch panel 7071 is also referred to as a touchscreen. The touch panel 7071 may include two parts: a touch detection apparatus and a touch controller. The other input devices 7072 may include but are not limited to a physical keyboard, a function key (such as a volume control key or a power on/off key), a trackball, a mouse, and a joystick. Details are not described herein.

In this embodiment, after receiving downlink data from a network-side device, the radio frequency unit 701 may transmit the downlink data to the processor 710 for processing. In addition, the radio frequency unit 701 may transmit uplink data to the network-side device. Generally, the radio frequency unit 701 includes but is not limited to an antenna, an amplifier, a transceiver, a coupler, a low noise amplifier, and a duplexer.

The memory 709 may be configured to store software programs or instructions and various data. The memory 709 may include first storage area for storing programs or instructions and a second storage area for storing data. The first storage area may store an operating system, an application program or instruction required by at least one function (for example, a sound playback function or an image playback function), and the like. In addition, the memory 709 may include either a volatile memory or a non-volatile memory, or the memory 709 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 709 in this embodiment of this application includes but is not limited to these and any other suitable types of memories.

The processor 710 may include one or more processing units. In some embodiments, an application processor and a modem processor are integrated in the processor 710. The application processor primarily processes operations relating to an operating system, user interfaces, application programs, and the like. The modem processor primarily processes radio communication signals, for example, being a baseband processor. It can be understood that the modem processor may be not integrated in the processor 710.

The radio frequency unit 701 is configured to receive a first synchronization signal block SSB.

The processor 710 is configured to determine, based on the first SSB, whether a wake-up signal WUS transmission condition is met.

In an embodiment of this application, the terminal may determine, based on the received SSB, whether the WUS transmission condition is met. In this way, the terminal can reasonably determine whether the network-side device needs to be awakened, which can ensure that communication performance of the terminal is not affected by the network-side device being in the energy-saving mode.

In some embodiments, the processor 710 is further configured to, in a case that a subcarrier offset information field value of the first SSB is a first value, determine that the WUS transmission condition is met, where the first value is used for indicating that the first SSB is a non-cell-defining SSB.

In some embodiments, the processor 710 is further configured to, in a case that a subcarrier offset information field value of the first SSB is a first value and a first cell identifier is an energy-saving cell identifier, determine that the WUS transmission condition is met, where the first cell identifier is an identifier of a cell transmitting the first SSB, and the first value is used for indicating that the first SSB is a non-cell-defining SSB.

In some embodiments, the processor 710 is further configured to, in a case that a subcarrier offset information field value of the first SSB is a second value and a first cell identifier is an energy-saving cell identifier, determine that the WUS transmission condition is met; where

the second value is used for indicating that the first SSB is a non-cell-defining SSB, the first SSB indicates the presence of a cell-defining SSB, and the first cell identifier is an identifier of a cell transmitting the first SSB.

In some embodiments, the processor 710 is further configured to, in a case that a subcarrier offset information field value of the first SSB is a second value and a first cell identifier is ab energy-saving cell identifier, if the terminal detects no SSB at a target global synchronization channel number GSCN in a cell-defining SSB reception window duration, determine that the WUS transmission condition is met, where the target GSCN is a GSCN of a cell-defining SSB indicated by the first SSB, and the cell-defining SSB reception window duration is prescribed by a protocol or pre-configured.

In some embodiments, the processor 710 is further configured to, in a case that a subcarrier offset information field value of the first SSB is a second value, a first cell identifier is an energy-saving cell identifier, and no energy-saving cell SSB period is pre-configured, determine that the WUS transmission condition is met; where

the second value is used for indicating that the first SSB is a non-cell-defining SSB, the first SSB indicates the presence of a cell-defining SSB, and the first cell identifier is an identifier of a cell transmitting the first SSB.

In some embodiments, the processor 710 is further configured to, in a case that the subcarrier offset information field value of the first SSB is the second value, the first cell identifier is the energy-saving cell identifier, and no energy-saving cell SSB period is pre-configured, if the terminal detects no SSB at a target global synchronization channel number GSCN in a cell-defining SSB reception window duration, determine that the WUS transmission condition is met, where the target GSCN is a GSCN of the cell-defining SSB indicated by the first SSB, and the cell-defining SSB reception window duration is prescribed by a protocol or pre-configured.

In some embodiments, the radio frequency unit 701 is further configured to, in a case that the energy-saving cell SSB period has been pre-configured, detect, based on the energy-saving cell SSB period, an SSB at a frequency domain position corresponding to the target GSCN.

In some embodiments, the radio frequency unit 701 is further configured to, in a case that the terminal determines that the WUS transmission condition is met, transmit a WUS to the cell transmitting the first SSB.

In some embodiments, the radio frequency unit 701 is further configured to receive energy-saving cell configuration information configured by a serving cell, where the energy-saving cell configuration information includes at least one of:

an energy-saving cell identifier;

an energy-saving cell WUS reception parameter;

an energy-saving cell WUS reception offset value;

an energy-saving cell SSB period; and

a cell-defining SSB reception window duration.

In some embodiments, the processor 710 is further configured to, determine, based on the energy-saving cell configuration information, whether the first cell identifier is an energy-saving cell identifier.

In some embodiments, the processor 710 and the radio frequency unit 701 is further configured to, in a case that the terminal determines that the WUS transmission condition is met, transmit, based on the energy-saving cell configuration information, a WUS to a cell transmitting the first SSB.

In some embodiments, the energy-saving cell WUS reception parameter includes at least one of the following:

energy-saving cell WUS reception frame number;

energy-saving cell WUS reception subframe number;

energy-saving cell WUS reception slot number;

energy-saving cell WUS reception symbol number; and

energy-saving cell WUS reception resource block or WUS reception resource set.

In some embodiments, the energy-saving cell WUS reception offset value includes at least one of the following:

an offset value between an energy-saving cell WUS reception position and a position at which the first SSB is detected by the terminal; and

an offset value between the energy-saving cell WUS reception position and a predefined parameter, where the predefined parameter includes at least one of predefined frame number, predefined subframe number, predefined slot number, and predefined symbol number.

In some embodiments, the processor 710 is further configured to, in a case that the first SSB is an SSB transmitted by the serving cell, determine, according to a measurement result of the first SSB, whether the WUS transmission condition is met.

In some embodiments, the processor 710 is further configured to, in a case that the measurement result of the first SSB is lower than a WUS configuration parameter corresponding to a mobility state of the terminal, determine that the WUS transmission condition is met, where the WUS configuration parameter is configured by the serving cell.

In some embodiments, the WUS configuration parameter includes at least one of the following:

a first parameter, where the first parameter is a parameter used by the terminal in a first mobility state;

a second parameter, where the first parameter is a parameter used by the terminal in a second mobility state; and

a third parameter, the first parameter is a parameter used by the terminal in a third mobility state; where

a moving speed corresponding to the first mobility state is less than a moving speed corresponding to the second mobility state, and the moving speed corresponding to the second mobility state is less than a moving speed corresponding to the third mobility state.

In some embodiments, the first parameter, the second parameter, and the third parameter are respectively a first threshold, a second threshold, and a third threshold; or

the first parameter is a first threshold, the second parameter is a first proportional factor of the first threshold, and the third parameter is a second proportional factor of the first threshold.

In some embodiments, the radio frequency unit 701 is further configured to in a case that the terminal determines that the WUS transmission condition is met, report a first message to the serving cell, where the first message is used for indicating a condition that the WUS transmission condition meets.

In summary, in this embodiment of this application, the terminal may determine, based on the received SSB, whether the WUS transmission condition is met. In this way, the terminal can reasonably determine whether the network-side device needs to be awakened, which can ensure that communication performance of the terminal is not affected by the network-side device being in the energy-saving mode.

An embodiment of this application further provides a network-side device, including a processor and a communication interface, where the communication interface is configured to receive a wake-up signal WUS transmitted by a terminal, and the processor is configured to switch a synchronization signal block SSB transmission period from a first period to a second period, where a duration of the first period is longer than a duration of the second period. The network-side device embodiment corresponds to the foregoing network-side device method embodiment. All implementations in the foregoing method embodiment may be applicable to the network-side device embodiment, with the same technical effect achieved.

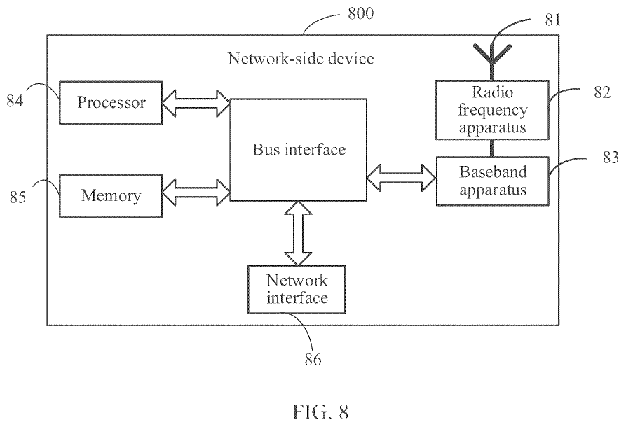

An embodiment of this application further provides a network-side device. As shown in FIG. 8, the network-side device 800 includes: an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information through the antenna 81, and transmits the received information to the baseband apparatus 83 for processing. In a downlink direction, the baseband apparatus 83 processes to-be-transmitted information, and transmits the information to the radio frequency apparatus 82; and the radio frequency apparatus 82 processes the received information and then transmits the information out through the antenna 81.

The method performed by the network-side device in the foregoing embodiment may be implemented in the baseband apparatus 83, and the baseband apparatus 83 includes a baseband processor.

The baseband apparatus 83 may include, for example, at least one baseband board, where a plurality of chips are disposed on the baseband board. As shown in FIG. 8, one of the chips is, for example, the baseband processor, and connected to the memory 85 through a bus interface, to invoke the program in the memory 85 to perform the operations of the network device shown in the foregoing method embodiment.

The network-side device may further include a network interface 86, where the interface is, for example, a Common Public Radio Interface (CPRI).

For example, the network-side device 800 in this embodiment of this application further includes: instructions or a program stored in the memory 85 and capable of running on the processor 84. The processor 84 invokes the instructions or program in the memory 85 to execute the method executed by the modules shown in FIG. 5, with the same technical effects achieved. To avoid repetition, details are not described herein again.

An embodiment of this application further provides a readable storage medium, where the readable storage medium stores a program or instructions, and when the program or instructions are executed by a processor, the processes of the foregoing signal transmission condition determining method embodiments can be implemented, with same technical effects achieved. To avoid repetition, details are not described herein again.

The processor is a processor in the terminal described in the foregoing embodiment. The readable storage medium includes a computer-readable storage medium such as a computer read-only memory ROM, a random access memory RAM, a magnetic disk, or an optical disc.

An embodiment of this application further provides a chip, where the chip includes a processor and a communication interface, the communication interface is coupled to the processor, and the processor is configured to run a program or instructions to implement each process of the foregoing signal transmission condition determining method embodiment, with the same technical effect achieved. To avoid repetition, details are not described herein again.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and the computer program/program product is executed by at least one processor to implement the processes of the foregoing embodiments of the foregoing signal transmission condition determining method, with the same technical effects achieved. To avoid repetition, the details are not repeated herein.

An embodiment of this application further provides a communication system, including a terminal and a network-side device, where the terminal may be configured to execute the steps of the signal transmission condition determining method as described above, and the network-side device may be configured to execute the steps of the SSB period control method as described above.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, persons skilled in the art may clearly understand that the method in the foregoing embodiment may be implemented by software with a necessary general hardware platform. The method in the foregoing embodiment may also be implemented by hardware. In some embodiments, the technical solutions of this application essentially or the part contributing to the prior art may be implemented in a form of a software product. The software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A signal transmission condition determining method, comprising
receiving, by a terminal, a first Synchronization Signal Block (SSB); and
determining, by the terminal based on the first SSB, whether a Wake-Up Signal (WUS) transmission condition is met.

2. The signal transmission condition determining method according to claim 1, wherein determining, by the terminal based on the first SSB, whether the WUS transmission condition is met comprises:
when a subcarrier offset information field value of the first SSB is a first value, determining, by the terminal, that the WUS transmission condition is met, wherein the first value is used for indicating that the first SSB is a non-cell-defining SSB.

3. The signal transmission condition determining method according to claim 1, wherein determining, by the terminal based on the first SSB, whether the WUS transmission condition is met comprises:
when a subcarrier offset information field value of the first SSB is a first value and a first cell identifier is an energy-saving cell identifier, determining, by the terminal, that the WUS transmission condition is met, wherein the first cell identifier is an identifier of a cell transmitting the first SSB, and the first value is used for indicating that the first SSB is a non-cell-defining SSB.

4. The signal transmission condition determining method according to claim 1, wherein determining, by the terminal based on the first SSB, whether the WUS transmission condition is met comprises:
when a subcarrier offset information field value of the first SSB is a second value and a first cell identifier is an energy-saving cell identifier, determining, by the terminal, that the WUS transmission condition is met,
wherein:
the second value is used for indicating that the first SSB is a non-cell-defining SSB,
the first SSB indicates the presence of a cell-defining SSB, and
the first cell identifier is an identifier of a cell transmitting the first SSB.

5. The signal transmission condition determining method according to claim 4, wherein when the subcarrier offset information field value of the first SSB is the second value and the first cell identifier is the energy-saving cell identifier, determining, by the terminal, that the WUS transmission condition is met comprises:
when the subcarrier offset information field value of the first SSB is the second value, the first cell identifier is the energy-saving cell identifier, and the terminal detects no SSB at a frequency domain position corresponding to a target Global Synchronization Channel Number (GSCN) in a cell-defining SSB reception window duration, determining, by the terminal, that the WUS transmission condition is met, wherein the target GSCN is a GSCN of the cell-defining SSB indicated by the first SSB, and the cell-defining SSB reception window duration is prescribed by a protocol or pre-configured.

6. The signal transmission condition determining method according to claim 1, wherein determining, by the terminal based on the first SSB, whether the WUS transmission condition is met comprises:
when a subcarrier offset information field value of the first SSB is a second value, a first cell identifier is an energy-saving cell identifier, and no energy-saving cell SSB period is pre-configured, determining, by the terminal, that the WUS transmission condition is met, wherein:
the second value is used for indicating that the first SSB is a non-cell-defining SSB,
the first SSB indicates the presence of a cell-defining SSB, and
the first cell identifier is an identifier of a cell transmitting the first SSB.

7. The signal transmission condition determining method according to claim 6, wherein when the subcarrier offset information field value of the first SSB is the second value, the first cell identifier is the energy-saving cell identifier, and no energy-saving cell SSB period is pre-configured, determining, by the terminal, that the WUS transmission condition is met comprises:
when the subcarrier offset information field value of the first SSB is the second value, the first cell identifier is the energy-saving cell identifier, no energy-saving cell SSB period is pre-configured, and the terminal detects no SSB at a target Global Synchronization Channel Number (GSCN) in a cell-defining SSB reception window duration, determining, by the terminal, that the WUS transmission condition is met, wherein the target GSCN is a GSCN of the cell-defining SSB indicated by the first SSB, and the cell-defining SSB reception window duration is prescribed by a protocol or pre-configured.

8. The signal transmission condition determining method according to claim 6, further comprising:
when the energy-saving cell SSB period has been pre-configured, detecting, by the terminal based on the energy-saving cell SSB period, an SSB at a frequency domain position corresponding to the target Global Synchronization Channel Number (GSCN).

9. The signal transmission condition determining method according to claim 2, further comprising:
when the terminal determines that the WUS transmission condition is met, transmitting, by the terminal, a WUS to the cell transmitting the first SSB.

10. The signal transmission condition determining method according to claim 3, further comprising:
receiving, by the terminal, energy-saving cell configuration information configured by a serving cell, wherein the energy-saving cell configuration information comprises at least one of:
an energy-saving cell identifier;
an energy-saving cell WUS reception parameter;
an energy-saving cell WUS reception offset value;
an energy-saving cell SSB period; or
a cell-defining SSB reception window duration.

11. The signal transmission condition determining method according to claim 10, further comprising:
determining, by the terminal based on the energy-saving cell configuration information, whether the first cell identifier is an energy-saving cell identifier; or
when the terminal determines that the WUS transmission condition is met, transmitting, by the terminal based on the energy-saving cell configuration information, a WUS to a cell transmitting the first SSB.

12. The signal transmission condition determining method according to claim 10, wherein the energy-saving cell WUS reception parameter comprises at least one of the following:
energy-saving cell WUS reception frame number;
energy-saving cell WUS reception subframe number;
energy-saving cell WUS reception slot number;
energy-saving cell WUS reception symbol number; or
energy-saving cell WUS reception resource block or WUS reception resource set.

13. The signal transmission condition determining method according to claim 10, wherein the energy-saving cell WUS reception offset value comprises at least one of the following:
an offset value between an energy-saving cell WUS reception position and a position at which the first SSB is detected by the terminal; or
an offset value between the energy-saving cell WUS reception position and a predefined parameter, wherein the predefined parameter comprises at least one of predefined frame number, predefined subframe number, predefined slot number, or predefined symbol number.

14. The signal transmission condition determining method according to claim 1, wherein determining, by the terminal based on the first SSB, whether the WUS transmission condition is met comprises:
when the first SSB is an SSB transmitted by the serving cell, determining, by the terminal according to a measurement result of the first SSB, whether the WUS transmission condition is met.

15. The signal transmission condition determining method according to claim 14, wherein determining, by the terminal according to the measurement result of the first SSB, whether the WUS transmission condition is met comprises:
when the measurement result of the first SSB is lower than a WUS configuration parameter corresponding to a mobility state of the terminal, determining, by the terminal, that the WUS transmission condition is met, wherein the WUS configuration parameter is configured by the serving cell.

16. The signal transmission condition determining method according to claim 15, wherein the WUS configuration parameter comprises at least one of the following:
a first parameter, wherein the first parameter is a parameter used by the terminal in a first mobility state;
a second parameter, wherein the first parameter is a parameter used by the terminal in a second mobility state; or
a third parameter, the first parameter is a parameter used by the terminal in a third mobility state, wherein:
a moving speed corresponding to the first mobility state is less than a moving speed corresponding to the second mobility state, and the moving speed corresponding to the second mobility state is less than a moving speed corresponding to the third mobility state.

17. The signal transmission condition determining method according to claim 16,
wherein:
the first parameter, the second parameter, and the third parameter are respectively a first threshold, a second threshold, and a third threshold, or
the first parameter is a first threshold, the second parameter is a first proportional factor of the first threshold, and the third parameter is a second proportional factor of the first threshold.

18. The signal transmission condition determining method according to claim 14, further comprising:
when the terminal determines that the WUS transmission condition is met, reporting, by the terminal, a first message to the serving cell, wherein the first message is used for indicating a condition that the WUS transmission condition meets.

19. A Synchronization Signal Block (SSB) period control method, comprising:
receiving, by a network-side device, a Wake-Up Signal (WUS) transmitted by a terminal; and
switching, by the network-side device, an SSB transmission period from a first period to a second period, wherein a duration of the first period is longer than a duration of the second period.

20. A terminal, comprising: a processor; and a memory, having a computer program or an instruction stored thereon, wherein the computer program or the instruction, when executed by the processor, causes the processor to perform operations comprising:
receiving a first Synchronization Signal Block (SSB), and
determining whether a Wake-Up Signal (WUS) transmission condition is met based on the first SSB.
